(19) United States
(12) Patent Application Publication
(10) Pub. No.: US 2024/0164453 A1
(43) Pub. Date: May 23, 2024

(54) AEROSOL GENERATING DEVICE AND OPERATION METHOD THEREOF

(71) Applicant: KT&G CORPORATION, Daejeon (KR)

(72) Inventors: Yong Hwan KIM, Gyeonggi-do (KR); Dong Sung KIM, Seoul (KR); Seung Won LEE, Gyeonggi-do (KR); Seok Su JANG, Daejeon (KR); Dae Nam HAN, Seoul (KR)

(73) Assignee: KT&G CORPORATION, Daejeon (KR)

(21) Appl. No.: 18/284,336

(22) PCT Filed: Jun. 9, 2022
(86) PCT No.: PCT/KR2022/008104

§ 371 Date: Sep. 27, 2023

(30) Foreign Application Priority Data
Jun. 23, 2021 (KR) 10-2021-0081851

(51) Int. Cl. A24F 40/51; A24F 40/485; A24F 40/57; A24F 40/60; A24F 40/20; A24F 40/465

(52) U.S. Cl. CPC A24F 40/51; A24F 40/485; A24F 40/57; A24F 40/60; A24F 40/20; A24F 40/465

(57) ABSTRACT

Disclosed is an aerosol generating device including: a housing including an air flow passage; a sensor deformable by an air flow in the air flow passage, and including a resistor having a resistance value that varies according to a degree of deformation of the sensor; and a processor electrically connected to the sensor, and configured to: measure the resistance value of the resistor; and detect a puff based on the measured resistance value being maintained at or above a first threshold value during a first time interval.

### TECHNICAL FIELD

One or more embodiments relate to an aerosol generating device and an operation method thereof, and more particularly, to an aerosol generating device for detecting a puff via a resistance change according to an air flow and an operation method thereof.

### BACKGROUND ART

Recently, the demand for alternative methods to overcome the shortcomings of general cigarettes has increased. For example, there is an increasing demand for a method of generating aerosol by heating an aerosol generating material, rather than by burning cigarettes. Accordingly, research on a heating-type aerosol generating device is being actively conducted.

An aerosol generating device may determine a use state thereof and deliver information about the use state to a user. For example, the aerosol generating device may detect a user's puffs.

### DISCLOSURE OF INVENTION

### Technical Problem

A puff may be detected via a pressure sensor arranged in a separate chamber distinct from an air flow passage. However, in this case, the arrangement location of the pressure sensor may be limited, the pressure sensor may be vulnerable to contamination, and puff detection may not be accurate.

The technical problems of the present disclosure are not limited to the above-described description, and other technical problems may be clearly understood by one of ordinary skill in the art from the embodiments to be described hereinafter.

### Solution to Problem

One or more embodiments provide an aerosol generating device capable of precisely detecting a user's puff by detecting an air flow and an operation method thereof.

According to one or more embodiments, an aerosol generating device includes: a housing including an air flow passage; a sensor deformable by an air flow in the air flow passage, and including a resistor having a resistance value that varies according to a degree of deformation of the sensor; and a processor electrically connected to the sensor, and configured to: measure the resistance value of the resistor; and detect a puff based on the measured resistance value being maintained at or above a first threshold value during a first time interval.

According to one or more embodiments, an operation method of an aerosol generating device, includes: measuring a resistance value via a sensor that is deformable by an air flow in an air flow passage and includes a resistor having a resistance value that varies according to a degree of deformation of the sensor; and detecting a puff based on the measured resistance value being maintained at or above a first threshold value during a first time interval.

### Advantageous Effects of Invention

An aerosol generating device according to one or more embodiments may implement a high-sensitivity puff detection function.

Also, a sensor included in the aerosol generating device according to one or more embodiments may have a relatively small volume and may be arranged at any location where an air flow if formed by a user's puff, thereby enabling a more flexible internal design of the aerosol generating device.

Effects of the present disclosure are not limited to the above effects, and effects that are not mentioned could be clearly understood by one of ordinary skill in the art from the present specification and the attached drawings.

### BRIEF DESCRIPTION OF DRAWINGS

FIG. 1 is a diagram illustrating an aerosol generating device according to an embodiment.

FIG. 2 is a diagram illustrating an aerosol generating device according to another embodiment.

FIG. 3 is a diagram illustrating an aerosol generating device according to another embodiment.

FIG. 4 is a graph for explaining a puff detection method of an aerosol generating device.

FIG. 5A is a view illustrating an aspect of a sensor unit including a resistor according to an embodiment.

FIG. 5B is a view illustrating another aspect of a sensor unit including a resistor according to an embodiment.

FIG. 5C is a view illustrating another aspect of a sensor unit including a resistor according to an embodiment.

FIG. 6 is a view illustrating a sensor unit including a plurality of resistors according to an embodiment.

FIG. 7A is a view illustrating an aspect of a sensor unit according to an embodiment.

FIG. 7B is a view illustrating another aspect of a sensor unit according to an embodiment.

FIG. 7C is a view illustrating another aspect of a sensor unit according to an embodiment.

FIG. 8A is a view illustrating an aspect of a sensor unit according to another embodiment.

FIG. 8B is a view illustrating another aspect of a sensor unit according to another embodiment.

FIG. 9A is a view illustrating an aspect of a sensor unit according to another embodiment.

FIG. 9B is a view illustrating another aspect of a sensor unit according to another embodiment.

FIG. 10 is a flowchart illustrating an operation method of an aerosol generating device, according to an embodiment.

### MODE FOR THE INVENTION

With respect to the terms used to describe the various embodiments, general terms which are currently and widely used are selected in consideration of functions of structural elements in the various embodiments of the present disclosure. However, meanings of the terms can be changed according to intention, a judicial precedence, the appearance of new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and/or operation and can be implemented by hardware components or software components and combinations thereof.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

In this specification, “time interval” only defines a length of time, and does not indicate a particular timing.

Hereinafter, the present disclosure will now be described more fully with reference to the accompanying drawings, in which exemplary embodiments of the present disclosure are shown such that one of ordinary skill in the art may easily work the present disclosure. The disclosure can, however, be embodied in many different forms and should not be construed as being limited to the embodiments set forth herein.

Also, although the terms first, second, etc. may be used herein to describe various elements or components, these elements or components should not be limited by these terms. These terms are only used to distinguish one element or component from another element or component.

In addition, some of elements or components in the drawings may be illustrated with a slightly exaggerated size or proportion. Also, elements or components illustrated in some drawings may not be illustrated in the other drawings.

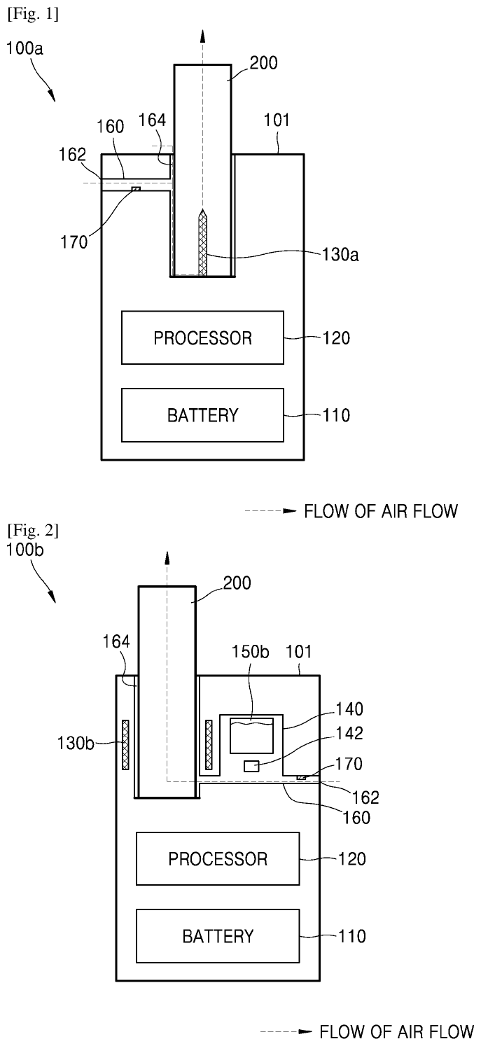

As used herein, a “longitudinal direction” of an element or component may refer to a lengthwise direction in which an element extends along one axis direction of the element. Here, the one axis direction of the element may refer to a direction in which the element may extend longer than along the other axis directions transverse to the one axis direction. For example, a longitudinal direction of an aerosol generating device may refer to a direction that is parallel to a direction in which an air flow is discharged from the aerosol generating device as illustrated in FIGS. 1 to 3.

As used herein, “embodiments” are any distinctions for easily describing the invention in the present disclosure, and the embodiments need not to be exclusive to each other. For example, elements described in an embodiment may be applied and/or implemented in other embodiments, and may be modified and applied and/or implemented without departing from the scope of the present disclosure.

Also, the terminology used herein is for the purpose of describing embodiments only and is not intended to be limiting of the embodiments. As used herein, the singular forms are intended to include the plural forms as well, unless the context clearly indicates otherwise.

Hereinafter, embodiments will be described in detail with reference to the accompanying drawings.

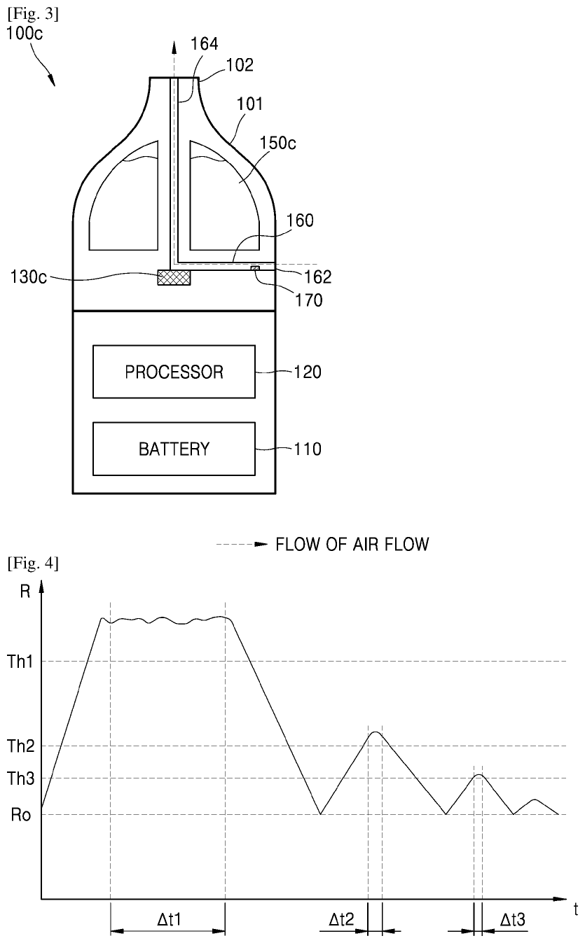

FIG. 1 is a diagram illustrating an aerosol generating device according to an embodiment. FIG. 2 is a diagram illustrating an aerosol generating device according to another embodiment. FIG. 3 is a diagram illustrating an aerosol generating device according to another embodiment.

Referring to FIG. 1, an aerosol generating device 100a according to an embodiment may include a battery 110, a processor 120, a heater 130a, an air flow passage 160, and a sensor unit 170. Also, an aerosol generating article 200 may be inserted into an inner space (i.e., cavity) of a housing 101 of the aerosol generating device 100a.

Referring to FIG. 2, an aerosol generating device 100b according to another embodiment may include a battery 110, a processor 120, a heater 130b, a vaporizer 140, an air flow passage 160, and a sensor unit 170.

Referring to FIG. 3, an aerosol generating device 100c according to another embodiment may include a battery 110, a processor 120, a heater 130c, a liquid storage 150c, an air flow passage 160, and a sensor unit 170.

The aerosol generating devices 100a, 100b, and 100c illustrated in FIGS. 1 to 3 include elements related to the present embodiments. Accordingly, it will be understood by one of ordinary skill in the art that the aerosol generating devices 100a, 100b, and 100c may further include other elements, in addition to the elements illustrated in FIGS. 1 to 3.

When the aerosol generating article 200 (e.g., cigarette) is inserted into the aerosol generating device 100a or 100b, the aerosol generating device 100a or 100b may generate an aerosol from the aerosol generating article 200 and/or the vaporizer 140 by operating the heater 130a or 130b and/or the vaporizer 140. The aerosol generated by the heater 130a or 130b and/or the vaporizer 140 may pass through the aerosol generating article 200 to be delivered to a user. Here, the aerosol may refer to a gas in a state in which vaporized particles generated from an aerosol generating material and air are mixed.

As needed, even when the aerosol generating article 200 is not inserted into the aerosol generating devices 100a, 100b, and 100c, the aerosol generating devices 100a, 100b, and 100c may heat the heaters 130a, 130b, and 130c.

For example, the aerosol generating device 100a according to an embodiment may remove the residue in the inner space of the housing 101 by heating the heater 130a while the aerosol generating article 200 is not inserted.

As another example, the aerosol generating device 100c according to another embodiment may generate an aerosol by evaporating the liquid aerosol generating material stored in the liquid storage 150c while the aerosol generating article 200 is not inserted.

The battery 110 supplies electric power to be used for the aerosol generating device 100a, 100b or 100c to operate. For example, the battery 110 may supply power such that the heater 130a, 130b, or 130c or the vaporizer 140 may be heated, and may supply power needed for the processor 120 to operate. Also, the battery 110 may supply power needed for a display, a sensor, a motor, and the like installed in the aerosol generating device 100a, 100b, or 100c to operate.

The processor 120 controls overall operation of the aerosol generating device 100a, 100b, or 100c. In detail, the processor 120 controls operations of other elements included in the aerosol generating device 100a, 100b, or 100c, as well as operations of the battery 110, the heater 130a, 130b, or 130c, and the vaporizer 140. In addition, the processor 120 may determine whether or not the aerosol generating device 100a, 100b, or 100c is in an operable state by checking a state of each of the elements of the aerosol generating device 100a, 100b, or 100c.

The processor 120 can be implemented as an array of a plurality of logic gates or can be implemented as a combination of a general purpose microprocessor and a memory in which a program executable in the microprocessor is stored. It will be understood by one of ordinary skill in the art that the processor can be implemented in other forms of hardware.

The heater 130a, 130b, or 130c may be operated by power supplied from the battery 110. For example, when the aerosol generating article 200 is inserted into the aerosol generating device 100a or 100b, the heater 130b may be located outside the aerosol generating article 200. Accordingly, the heated heater 130b may increase a temperature of the aerosol generating material inside the aerosol generating article 200.

The heater 130a, 130b or 130c may include an electro-resistive heater. For example, the heater 130a, 130b or 130c may include an electrically conductive track, and the heater 130a, 130b or 130c may be heated when currents flow through the electrically conductive track. However, the heater 130a, 130b or 130c is not limited to the example described above and may include all heaters which may be heated to a desired temperature. Here, the desired temperature may be pre-set in the aerosol generating device 100a, 100b or 100c or may be set as a temperature desired by a user.

As another example, the heater 130a, 130b or 130c may include an induction heater. In detail, the heater 130a or 130b may include an electrically conductive coil for heating a cigarette in an induction heating method, and the cigarette may include a susceptor which may be heated by the induction heater.

For example, the heater 130a, or 130b may include a tube-type heating element, a plate-type heating element, a needle-type heating element, or a rod-type heating element, and may heat the inside or the outside of the aerosol generating article 200, according to the shape of the heating element.

Also, the aerosol generating device 100a, 100b or 100c may include a plurality of heaters 130a, 130b or 100c. Here, the plurality of heaters 130a, 130b or 100c may be inserted into the aerosol generating article 200 or may be arranged outside the aerosol generating article 200. Also, some of the plurality of heaters 130a, 130b or 130c may be inserted into the aerosol generating article 200 and the others may be arranged outside the aerosol generating article 200. In addition, the shape of the heater 130a, 130b or 130c is not limited to the shapes illustrated in FIGS. 1 through 2 and may include various shapes.

The aerosol generating article 200 may be similar to a general combustive cigarette. For example, the aerosol generating article 200 may be divided into a first portion including the aerosol generating material and a second portion including a filter and the like. Alternatively, the second portion of the aerosol generating article 200 may also include an aerosol generating material. For example, an aerosol generating material made in the form of granules or capsules may be inserted into the second portion.

A tobacco rod included in the aerosol generating article 200 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but is not limited thereto. Also, the tobacco rod may include other additives, such as flavors, a wetting agent, and/or organic acid. In addition, the tobacco rod may include a flavoring liquid, such as menthol or a moisturizer, which is injected into the tobacco rod.

The tobacco rod may be manufactured in various forms. For example, the tobacco rod may be formed as a sheet or a strand. Also, the tobacco rod may be formed as pipe tobacco which is formed of tiny bits cut from a tobacco sheet. In addition, the tobacco rod may be surrounded by a heat conductive material. For example, the heat conductive material may be, but is not limited to, metal foil such as aluminum foil. For example, the heat conductive material surrounding the tobacco rod may increase heat conductivity applied to the tobacco rod by uniformly distributing heat transmitted to the tobacco rod, and thus may improve the taste of tobacco. Also, the heat conductive material surrounding the tobacco rod may function as a susceptor heated by an induction heater. Here, although not illustrated in the drawings, the tobacco rod may further include an additional susceptor, in addition to the heat conductive material surrounding the tobacco rod.

The entire first portion may be inserted into the aerosol generating device 100a or 100b, and the second portion may be exposed to the outside. Alternatively, only a portion of the first portion may be inserted into the aerosol generating device 100a or 100b, or the entire first portion and a portion of the second portion may be inserted into the aerosol generating device 100a or 100b. The user may puff the aerosol while holding the second portion by the mouth of the user. In this case, the aerosol is generated by external air passing through the first portion, and the generated aerosol passes through the second portion and is delivered to the user's mouth.

As another example, the aerosol generating device 100b or 100c may generate an aerosol from the aerosol generating material by using an ultrasonic vibration method. The ultrasonic vibration method may refer to a method of generating an aerosol by atomizing an aerosol generating material with ultrasonic vibration generated by a vibrator. The aerosol generating material may be vaporized and/or granulated to be atomized into aerosol by short period vibration generated by the vibrator. The vibrator may include, for example, piezoelectric ceramic. The piezoelectric ceramic is a functional material capable of converting generating electricity (i.e., voltage) to a physical force (i.e., pressure), and vice versa.

The vaporizer 140 may generate an aerosol by heating a liquid composition, and the generated aerosol may pass through the aerosol generating article 200 to be delivered to the user. In other words, the aerosol generated by the vaporizer 140 may move along the air flow passage 160 of the aerosol generating device 100b. The air flow passage 160 may be formed such that the aerosol generated by the vaporizer 140 may pass through the aerosol generating article 200 to be delivered to the user.

For example, the vaporizer 140 may include a liquid storage 150b, a liquid delivery element, and a heating element 142, but is not limited thereto. For example, the liquid storage 150b, the liquid delivery element, and the heating element 142 may be included in the aerosol generating device 100b as independent modules.

The liquid storage 150b or 150c may store a liquid composition. For example, the liquid composition may be a liquid including a tobacco-containing material having a volatile tobacco flavor component, or a liquid including a non-tobacco material. The liquid storage 150b may be formed to be attached/detached to/from the vaporizer 140 or may be formed integrally with the vaporizer 140.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures can be a mixture of at least one of vitamin A, vitamin B, vitamin C, and vitamin E, but are not limited thereto. In addition, the liquid composition may include an aerosol forming agent such as glycerin and propylene glycol.

For example, the liquid composition may include any weight ratio of glycerin and propylene glycol solution to which nicotine salts are added. The liquid composition may include two or more types of nicotine salts. Nicotine salts may be formed by adding suitable acids, including organic or inorganic acids, to nicotine. Nicotine may be a naturally generated nicotine or synthetic nicotine and may have any suitable weight concentration relative to the total solution weight of the liquid composition.

Acid for the formation of the nicotine salts may be appropriately selected in consideration of the rate of nicotine absorption in the blood, the operating temperature of the aerosol generating device 100b or 100c, the flavor or savor, the solubility, or the like. For example, the acid for the formation of nicotine salts may be a single acid selected from the group consisting of benzoic acid, lactic acid, salicylic acid, lauric acid, sorbic acid, levulinic acid, pyruvic acid, formic acid, acetic acid, propionic acid, butyric acid, valeric acid, caproic acid, caprylic acid, capric acid, citric acid, myristic acid, palmitic acid, stearic acid, oleic acid, linoleic acid, linolenic acid, phenylacetic acid, tartaric acid, succinic acid, fumaric acid, gluconic acid, saccharic acid, malonic acid or malic acid, or a mixture of two or more acids selected from the group, but is not limited thereto.

The liquid delivery element may deliver the liquid composition of the liquid storage 150b to the heating element 142. For example, the liquid delivery element may be a wick such as cotton fiber, ceramic fiber, glass fiber, or porous ceramic, but is not limited thereto.

The heating element 142 is an element for heating the liquid composition delivered by the liquid delivery element. For example, the heating element 142 may be a metal heating wire, a metal hot plate, a ceramic heater, or the like, but is not limited thereto. In addition, the heating element 142 may include a conductive filament such as nichrome wire and may be positioned as being wound around the liquid delivery element. The heating element 142 may be heated by a current supply and may transfer heat to the liquid composition in contact with the heating element 142, thereby heating the liquid composition. As a result, aerosol may be generated.

For example, the vaporizer 140 may be referred to as a cartomizer or an atomizer, but is not limited thereto.

The air flow passage 160 is a passage for an air flow inside the aerosol generating device 100a, 100b, or 100c. The air flow passage 160 may be included or formed inside the housing 101 such that the air flows inside the aerosol generating device 100a, 100b, or 100c. For example, external air may be introduced into the aerosol generating device 100a, 100b, or 100c through at least one through-hole formed in the aerosol generating device 100a, 100b, or 100c and discharged to the outside of the aerosol generating device 100a, 100b, or 100c through the at least one through-hole.

The air flow passage 160 may extend from a first through-hole 162 located in at least one area of the housing 101 to a second through-hole 164 located in another area of the housing 101 in the housing 101. When the user performs inhalation with respect to the aerosol generating device 100a, 100b, or 100c, external air may be introduced into the housing 101 through the first through-hole 162, and the introduced external air may be discharged to the outside of the aerosol generating device 100a, 100b, or 100c through the second through-hole 164, together with aerosol generated inside the aerosol generating device 100a, 100b, or 100c.

Also, referring to FIG. 1, external air may be introduced into the housing 101 through the second through-hole 164, and the introduced external air may enter the aerosol generating article 200 through at least one hole formed in a surface of the aerosol generating article 200 and discharged through one end portion of the aerosol generating article 200 exposed to the outside of the aerosol generating device 100a.

The first through-hole 162 may be provided in the form of a hole in the housing 101 of the aerosol generating device 100a, 100b, or 100c, or may be provided in the form of a gap between various elements forming the housing 101 of the aerosol generating device 100a, 100b, or 100c.

As an example, as illustrated in FIGS. 1 and 2, the second through-hole 164 may be formed between the aerosol generating article 200 and an inner space of the aerosol generating device 100a or 100b. As another example, as illustrated in FIG. 3, the second through-hole 164 may be arranged in a mouthpiece 102 that is to contact the user's mouth to enable inhalation with respect to the aerosol generating device 100c.

FIGS. 1 and 3 illustrate that the battery 110, the processor 120, and the heater 130a or 130c are arranged in series along the longitudinal direction of the aerosol generating device 100a or 100c, and the air flow passage 160 extends from a side of the aerosol generating device 100a or 100c to the inner space of the aerosol generating device 100a or 100c. FIG. 2 illustrates that the vaporizer 140 and the heater 130b are arranged in parallel, and the air flow passage 160 extends from a side of the aerosol generating device 100b along the vaporizer 140 and the inner space of the housing 101.

However, the internal structures of the aerosol generating devices 100a, 100b, and 100c are not limited to the structures illustrated in FIGS. 1 to 3. In other words, according to the design of the aerosol generating device 100a, 100b, or 100c, the battery 110, the processor 120, the heater 130a, 130b, or 130c, the vaporizer 140, the air flow passage 160, and the sensor unit 170 may be differently arranged.

The aerosol generating device 100a, 100b, or 100c may further include general-purpose elements in addition to the battery 110, the processor 120, the heater 130a, 130b, or 130c, the vaporizer 140, the air flow passage 160, and the sensor unit 170. For example, the aerosol generating device 100a, 100b, or 100c may further include a user interface (not shown) and a memory (not shown).

The user interface may provide the user with information regarding the state of the aerosol generating device 100a, 100b, or 100c. The user interface may include various types of interfacing elements such as a display or lamp outputting visual information, a motor outputting tactile information, a speaker outputting sound information, input/output (I/O) interfacing elements (e.g., a button and a touch screen) receiving information input from the user or outputting information to the user, terminals performing data communication or supplied with charging power, and a communication interfacing module performing wireless communication (e.g., WI-FI, WI-FI Direct, Bluetooth, Near-Field Communication (NFC), or the like) with an external device.

The memory may be hardware storing various types of data processed in the aerosol generating device 100a 100b, or 100c, and may store pieces of data processed by the processor 120 and pieces of data to be processed by the processor 120. The memory may be implemented as various types, such as random access memory (RAM) such as dynamic random access memory (DRAM) and static random access memory (SRAM), read-only memory (ROM), and electrically erasable programmable read-only memory (EEPROM).

The memory may store data about an operation time of the aerosol generating device 100a, 100b, or 100c, the maximum number of puffs, the current number of puffs, at least one temperature profile, and a smoking pattern of the user, and the like.

In addition, the aerosol generating device 100a, 100b, or 100c may include different types of sensors (e.g., a temperature sensor, an aerosol generating article insertion detection sensor, and the like).

The sensor unit 170 may include a puff detection sensor for detecting the user's inhalation with respect to the aerosol generating device 100a, 100b, or 100c. For example, the puff detection sensor may be a resistance-based sensor detecting a change in a resistance or an inductance-based sensor detecting a change in an inductance.

The sensor unit 170 may include a resistor. The resistance value of a resistor is affected by a length and a cross-sectional area thereof. For example, as the length of the resistor increases or the cross-sectional area of the resistor decreases, a resistance of the resistor may increase. An undeformed resistor may have an initial resistance value corresponding to an initial length and an initial cross-sectional area thereof, and a deformed resistor may have a changed resistance value in response to a modified length and a modified cross-sectional area thereof.

The sensor unit 170 may sense or measure an air flow inside the aerosol generating device 100a, 100b, or 100c. The sensor unit 170 may be deformed in shape by the air flow in the air flow passage 160 of the aerosol generating device 100a, 100b, or 100c. The sensor unit 170 may output a resistance value corresponding to an intensity of the air flow on the basis of the change in the resistance of the resistor, or the resistance value corresponding to the intensity of the air flow sensed by the sensor unit 170 may be delivered to the processor 120.

FIGS. 1 to 3 illustrate that the sensor unit 170 is located near the first through-hole 162 of the air flow passage 160, but the sensor unit 170 may also be located near the second through-hole 164. In other words, the location of the sensor unit 170 is not limited to the example described above, and the sensor unit 170 may be arranged at any location on the air flow path in the aerosol generating device 100a, 100b, or 100c. Therefore, the sensor unit 170 may be flexibly arranged or designed. Various embodiments and more detailed description of the sensor unit 170 will be described later with reference to the other drawings.

The processor 120 may be connected to the sensor unit 170 to receive information or data from the sensor unit 170 and detect whether or not a puff occurs with respect to the aerosol generating device 100a, 100b, or 100c. Here, the processor 120 and the sensor unit 170 may be connected via an electrical connection and/or wireless communication. The processor 120 and the sensor unit 170 may transmit and receive signals such as an optical signal and a magnetic signal.

The processor 120 may measure a resistance value of the resistor included in the sensor unit 170, which changes according to the degree of deformation of the sensor unit 170. When the measured resistance value being maintained at or above a preset threshold value during a predefined time, the processor may determine that a puff has occurred (i.e., a puff has been detected).

Here, the predefined time may be a reference time for determining whether a puff occurs, and may correspond to, for example, 0.2 seconds to 2.0 seconds. Also, the preset threshold value may be a reference value for determining whether a puff occurs. For example, for detection of a puff, the preset threshold value may be compared with the resistance value of the sensor unit 170 deformed by the user's inhalation with respect to the aerosol generating device 100a, 100b, or 100c.

The predefined time and/or the preset threshold value may be previously input into the processor 120 or the memory. For example, the predefined time and/or the preset threshold value may be preset by a manufacturer of the aerosol generating device 100a, 100b, or 100c, or may be set by a user after the aerosol generating device 100a, 100b, or 100c is sold to the user. The puff detection method of the aerosol generating devices 100a, 100b, and 100c will be described later in more detail with reference to FIG. 4.

In an embodiment, the processor 120 may analyze a result of sensing by at least one sensor and control subsequent processes. For example, the processor 120 may output a notification of a detected puff visually, auditorily, and/or tactilely.

The processor 120 may control the user interface on the basis of the result sensed by the sensor unit 170. The user interface may include a display, an LED, a speaker, a vibration motor, and the like. For example, the processor 120 may count the number of puff occurrences by using the puff detection sensor, and output the number of remaining puffs via the display.

Here, the number of remaining puffs may refer to the number of puffs remaining after subtracting the number of user's puffs counted up to now from the appropriate number of puffs predefined to correspond to a characteristic such as a type or a size of the aerosol generating article 200 or a characteristic such as a type or an amount of a material stored in the liquid storage 150b or 150c. The appropriate number of puffs may be stored in the memory or the processor 120.

Also, when the number of puffs reaches a predefined number after counting the number of puff occurrences, the processor 120 may notify the user via the user interface that the aerosol generating device 100a, 100b, or 100c will be terminated soon.

In another embodiment, on the basis of a result sensed by another type of sensor, the processor 120 may control power supplied to the heater 130a, 130b, or 130c to start or end an operation of the heater 130a, 130b, or 130c. Also, on the basis of the result sensed by another type of sensor, the processor 120 may control an amount of power supplied to the heater 130a, 130b, or 130c or a time for which power is supplied to the heater 130a, 130b, or 130c, such that the heater 130a, 130b, or 130c may be heated to a preset temperature or may maintain an appropriate temperature.

For example, when detecting a puff, the processor 120 may control power applied to the heater 130a, 130b, or 130c. In an example, when determining that the user performs inhalation with respect to the aerosol generating device 100a, 100b, or 100c by detecting a puff, the processor 120 may preheat the heater 130a, 130b, or 130c. Accordingly, the generation of aerosol may be easily started by the user simply performing inhalation with respect to the aerosol generating device 100a, 100b, or 100c.

As another example, when it is determined that the user performs inhalation with respect to the aerosol generating device 100a, 100b, or 100c (i.e., when a puff is detected), the processor 120 may increase a heating temperature by increasing power supplied to the heater 130a, 130b, or 130c. In other words, whenever the user performs inhalation with respect to the aerosol generating device 100a, 100b, or 100c, the processor 120 may increase the heating temperature such that an amount of aerosol may increase according to the user's inhalation timing.

In another embodiment, the processor 120 may perform detection of a puff with respect to the aerosol generating device 100a, 100b, or 100c when the heater 130a, 130b, or 130c operates. For example, the processor 120 may measure the resistance value of the sensor unit 170 only when the heater 130a, 130b, or 130c heats the aerosol generating article 200 inserted into the aerosol generating device 100a, 100b, or 100c, and may not measure the resistance value unless the heater 130a, 130b, or 130c heats the aerosol generating article 200.

As another example, the processor 120 may measure the resistance value of the sensor unit 170 only when the heater 130c operates to heat a liquid composition supplied from the liquid storage 150c, and may not measure the resistance value when the heater 130c is not operating.

In other words, the processor 120 may or may not measure the resistance value of the sensor unit 170 based on whether the heater 130a, 130b, or 130c is operating. Accordingly, when the heater 130a, 130b, or 130c is not operating, the processor 120 may not perform detection of a puff, and thus power consumption of the aerosol generating device 100a, 100b, or 100c may be reduced.

In another embodiment, the processor 120 may measure the resistance value of the sensor unit 170 at all times, and may also perform another process when the heater 130a, 130b, or 130c is operating. For example, the processor 120 may detect the occurrence of a puff with respect to the aerosol generating device 100a, 100b, or 100c by determining whether or not the resistance value is maintained at or above a threshold value during a predefined time interval only when the heater 130a, 130b, or 130c is operating.

Although not illustrated in FIGS. 1 through 3, the aerosol generating device 100a, 100b or 100c and an additional cradle may form together a system. For example, the cradle may be used to charge the battery 110 of the aerosol generating device 100a, 100b or 100c. Alternatively, the heater 130a, 130b or 130c may be heated when the cradle and the aerosol generating device 100a, 100b or 100c are coupled to each other.

The aerosol generating devices 100a, 100b, and 100c according to the embodiments described above have a substantially rectangular cross-sectional shape when taken perpendicular to the longitudinal direction thereof, but the embodiments are not limited thereto. The aerosol generating devices 100a, 100b, and 100c may have, for example, a circular, elliptical, or square cross-sectional shape, or various types of polygonal cross-sectional shapes. Also, when the aerosol generating devices 100a, 100b, and 100c are not limited to a structure extending linearly in its longitudinal direction. For example, the aerosol generating devices 100a, 100b, and 100c may be curved, for example, in a streamlined shape or bent at a predefined angle in a particular area for a comfortable grip.

FIG. 4 is a graph for explaining a puff detection method of an aerosol generating device.

FIG. 4 illustrates, over time, a change in a resistance value R measured by a sensor unit. In the graph illustrated in FIG. 4, a horizontal axis corresponds to an axis of time t, and a vertical axis corresponds to an axis of the resistance value R.

In an initial state in which there is no air flow, a resistor included in the sensor unit may have an initial resistance value Ro. The sensor unit may be deformed according to the air flow, and thus the resistance value R may be changed according to a change in a length and/or a cross-sectional area of the resistor included in the sensor unit.

For example, when a user performs inhalation with respect to an aerosol generating device, at least a portion of the sensor unit may be bent by the air flow, and accordingly the length of the resistor included in the sensor unit may increase and the cross-sectional area thereof may decrease, thereby increasing the resistance value R. Here, when the user's inhalation is sufficiently strong, the resistance value R measured from the sensor unit may increase to a value that is greater than a first threshold value Th1. When the user's inhalation is relatively weak, the resistance value R may not increase to the first threshold value Th1.

During the user's inhalation, the deformation state of the sensor unit may be maintained, and thus the resistance value R may be maintained near the increased value. For example, the measured resistance value R may be maintained, during a predefined first time interval At1, at a value that is greater than or equal to the first threshold value Th1. Here, the first time interval At1 may be an example of the predefined time described above, and may be 1 second to 2 seconds. As aforementioned, “time interval” only defines a length of time, and does not indicate a particular timing.

Meanwhile, a weak air flow may occur inside the aerosol generating device due to minute vibration of the aerosol generating device or change in atmosphere. In this case, the resistance value R may be less than the first threshold value Th1, or the resistance value R may increase to a value that is greater than or equal to the first threshold value Th1 but the increased resistance value may not be maintained for the predefined time. Accordingly, a change in the resistance value R may be considered noise that is not caused by a user's inhalation, and the processor may not determine that a puff has occurred.

In other words, the processor may detect a puff with respect to the aerosol generating device by considering not only the intensity of the user's inhalation but also a duration of the user's inhalation. In detail, the processor may determine that the puff has occurred only when both the intensity of the inhalation and the duration of the inhalation satisfy certain conditions. Accordingly, a puff detection may be more robust with respect to noise, and sensitivity and accuracy of detection may be improved.

When the user's inhalation is terminated, the air flow may vanish inside the aerosol generating device, and thus the deformed shape of the sensor unit may be restored. In the example illustrated in FIG. 4, the sensor unit may vibrate while being restored to a state in which an air flow is not present. Accordingly the resistance value R may oscillate between the first threshold value Th1 and the initial value Ro and converge to the initial value Ro.

In another example, according to the deformation state or the deformation aspect of the sensor unit, the resistance value R may attenuatively oscillate between the maximum value and the minimum value that is less than the initial value Ro, converging to the initial value Ro. In detail, the resistance value R of the deformed sensor unit may increase to a value that is greater than the first threshold value Th1, and then decrease to a value that is less than the initial value Ro as the user's inhalation is terminated.

FIG. 4 illustrates that the resistance value R linearly increases or decreases, but this is only an example. The resistance value R may nonlinearly increase or decrease according to the user's inhalation aspect (e.g., inhalation intensity) with respect to the aerosol generating device and/or characteristics of the sensor unit (e.g., the shape, structure, and the like thereof).

In another embodiment, the processor may determine that a puff has occurred if the resistance value R is maintained at or above (or at or below) a predefined value during a predefined time (i.e., for at least a predefined time), after it is maintained at or above the first threshold value Th1 during the first time interval At1 (i.e., for at least a time having a length of At1).

For example, the processor may determine that a puff has occurred when the resistance value R is maintained at or above a second threshold value Th2 during a second time interval At2 after being maintained at or above the first threshold value Th1 during the first time interval At1. Here, the second threshold value Th2 may be less than the first threshold value Th1, and the second time interval At2 may be shorter than the first time interval At1. For example, the first time interval At1 may be 1 second to 2 seconds, and the second time interval At2 may be 0.1 second to 0.2 seconds.

As described above, after measuring the increased resistance value R that is maintained according to the user's inhalation having a sufficient strength and intensity, the processor may detect a puff by further considering a process in which the resistance value R is restored. Accordingly, the processor may consider not only the start of the user's inhalation but also the end of the user's inhalation, and thus may more accurately detect a puff.

In addition, the processor may determine that the user's puff has occurred when the resistance value R is maintained at or above a third threshold value Th3 during a third time interval At3 thereafter in addition to the condition of being maintained at or above the second threshold value Th2 during the second time interval At2.

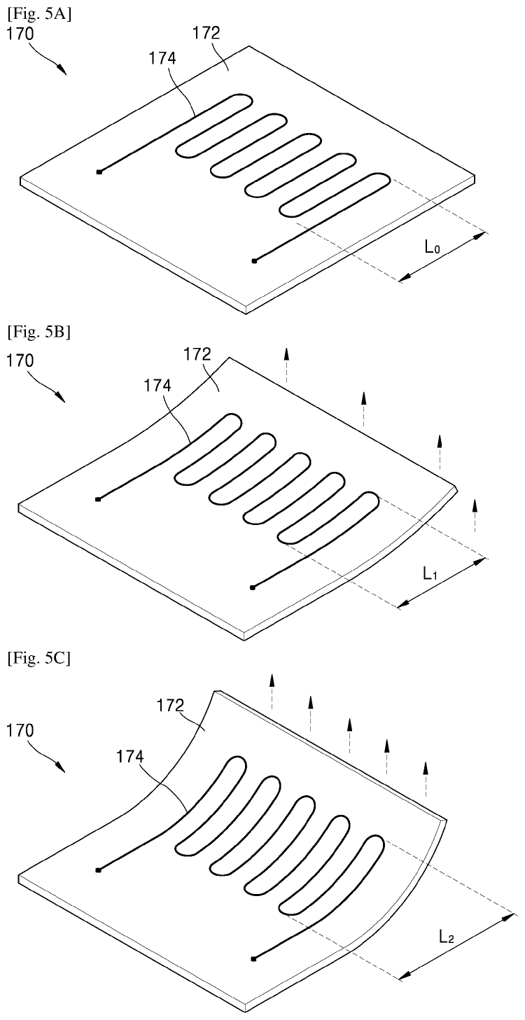

Hereinafter, detailed examples of a resistor and a sensor unit will be described with reference to FIGS. 5A to 9B.

FIG. 5A is a view illustrating an aspect of a sensor unit including a resistor according to an embodiment. FIG. 5B is a view illustrating another aspect of a sensor unit including a resistor according to an embodiment. FIG. 5C is a view illustrating another aspect of a sensor unit including a resistor according to an embodiment.

Referring to FIGS. 5A to 5C, a sensor unit 170 may include a resistor 174 and a base 172 on which the resistor 174 is arranged. Here, the base 172 may be deformed by an air flow, and a resistance of the resistor 174 may change in response to the deformation of the base 172. Although not illustrated, the sensor unit 170 may be connected to a processor (e.g., the processor 120 of FIGS. 1 to 3) to transmit and receive electrical signals, or may be connected to a battery (e.g., the battery 110 of FIGS. 1 to 3) to receive power.

The resistor 174 may be arranged on the base 172 such that the resistance thereof changes in response to the deformation of the base 172. For example, the resistor 174 may be mounted on a surface of the base 172 or buried inside the base 172.

The base 172 may be made of a material having a small rigidity such that it may be deformed by the air flow, or may be manufactured in a shape having a small rigidity. For example, the base 172 may be manufactured to have a small thickness or cross-sectional area.

The resistor 174 may include a metal material through which a current may flow. For example, the metal material may include copper, aluminum, nickel, silver, gold, platinum, palladium, or an alloy thereof, but is not limited thereto.

The resistor 174 may also include a material such as carbon powder, a carbon nanotube, or graphene.

The resistor 174 may be arranged on the base 172 by, for example, a plating method, a coating method such as deposition or spraying, or a printing method.

In an embodiment, the resistor 174 may be a strain gauge. The strain gauge may include a thin resistance line arranged in a winding pattern, such that a length of the strain gauge may be a multiple (e.g., 10 times) of a straight resistance line. Accordingly, in the strain gauge, a relatively great change in a resistance may occur even with a minute deformation.

In other words, when the resistor 174 having a strain gauge shape, even a minute deformation of the resistor 174 due to an air flow may cause a sufficient change in a resistance such that a puff may be sensed. Thus a strain gauge shape may be adapted for effective detection of a puff with respect to an aerosol generating device.

Referring to FIG. 5A, before deformation, a length of a portion of the resistor 174 in the sensor unit 170 (or the base 172) may be an initial length L₀. Referring to FIG. 5B, the length of the portion of the resistor 174 in the sensor unit 170 deformed by an air flow having a first intensity may be a first length L₁. Referring to FIG. 5C, the length of the portion of the resistor 174 in the sensor unit 170 deformed by an air flow having a second intensity that is stronger than the first intensity may be a second length L₂.

Here, the first length L₁ may be greater than the initial length L₀, and the second length L₂ may be greater than the first length L₁. In other words, as the intensity of an air flow increases, the deformation of the sensor unit 170 may increase. Accordingly, the deformation of the resistor 174 included in the sensor unit 170 may also increase, and thus a change in the resistance of the sensor unit 170 may also increase.

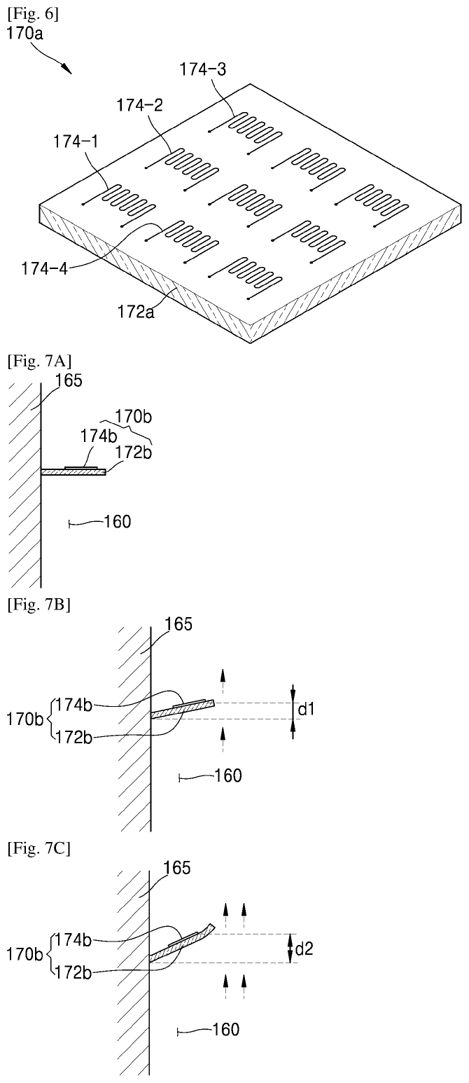

FIG. 6 is a view illustrating a sensor unit including a plurality of resistors according to an embodiment.

Referring to FIG. 6, a sensor unit 170a may include a plurality of resistors. For example, the sensor unit 170a may include an array in which a plurality of strain gauges 174-1, 174-2, 174-3, 174-4, . . . are arranged. The plurality of strain gauges 174-1, 174-2, 174-3, 174-4, . . . may be arranged on a base 172a at preset intervals, and the plurality of strain gauges 174-1, 174-2, 174-3, 174-4, . . . may be deformed in response to deformation of the base 172a.

Changes in resistances of the plurality of strain gauges 174-1, 174-2, 174-3, 174-4, . . . of the sensor unit 170a may be collected and analyzed, and thus a change in the resistance may be more precisely sensed. For example, even when the strain gauge 174-1 from among the plurality of the strain gauges 174-1, 174-2, 174-3, 174-4, . . . included in the sensor unit 170a is damaged, changes in resistances of the other strain gauges 174-2, 174-3, 174-4, . . . . may be collected. Therefore, the sensor unit 170a may sense a change in a resistance needed for determining whether or not a puff occurs.

Also, even when only a portion of the sensor unit 170a is locally deformed, a change in a resistance may be collected from at least one strain gauge 174-1 from among the plurality of strain gauges 174-1, 174-2, 174-3, 174-4, . . . , that is positioned at the deformed portion of the sensor unit 170a, and thus the sensor unit 170a may sense a change in a resistance needed for detecting a puff.

A direction in which the plurality of strain gauges 174-1, 174-2, 174-3, 174-4, . . . are deformed may vary according to a direction of an air flow, and accordingly changes in resistances thereof may also vary. Referring to FIG. 6, the plurality of strain gauges 174-1, 174-2, 174-3, 174-4, . . . are arranged in the same direction on the base 172a. However, the plurality of strain gauges 174-1, 174-2, 174-3, 174-4, . . . may be arranged in different directions. The sensor unit 170a including the plurality of strain gauges 174-1, 174-2, 174-3, 174-4, . . . arranged in different directions may be minimally affected by the direction of the air flow, thereby improving the reliability of measuring or sensing a change in resistance.

FIG. 7A is a view illustrating an aspect of a sensor unit according to an embodiment. FIG. 7B is a view illustrating another aspect of a sensor unit according to an embodiment. FIG. 7C is a view illustrating another aspect of a sensor unit according to an embodiment.

Referring to FIGS. 7A to 7C, a sensor unit 170b may be arranged in an air flow passage 160, and thus may be deformed in shape by an air flow in the air flow passage 160. For example, a base 172b included in the sensor unit 170b may be a cantilever, and may protrude from at least one area of an inner side 165 of the air flow passage 160.

The base 172b in the form of a cantilever may be attached to the inner side 165 of the air flow passage 160. For example, the base 172b may be welded or adhered to the inner side 165 of the air flow passage 160, or coupled to the inner side 165 of the air flow passage 160 by a fastening element such as a bolt. As another example, the base 172b may be fitted into a groove formed in the inner side 165 of the air flow passage 160.

In this way, the sensor unit 170b including the base 172b in the form of the cantilever may be easily arranged in the air flow passage 160. However, the coupling method of the base 172b and the air flow passage 160 is not limited thereto, the air flow passage 160 and the sensor unit 170b may be coupled to each other by other methods.

Referring to FIG. 7A, when there is no air flow in the air flow passage 160, the sensor unit 170b may not deformed, and a resistance of a resistor 174b may not be changed. Referring to FIG. 7B, when there is a weak air flow, a slight deformation d1 of the sensor unit 170b occur, and a small change in a resistance corresponding thereto may be sensed. Referring to FIG. 7C, when there is a strong air flow, deformation d2 of the sensor unit 170b may occur, and a change in a resistance corresponding thereto may be sensed.

The small deformation d1 of the sensor unit 170b as illustrated in FIG. 7B may be caused by, for example, vibration of an aerosol generating device or a difference in air pressure, rather than by a user's inhalation with respect to the aerosol generating device. A resistance value of the resistor 174b included in the sensor unit 170b according to the small deformation d1 may be less than a first threshold, and, at this time, a puff may not be detected.

Meanwhile, the deformation d2 of the sensor unit 170b as illustrated in FIG. 7C may be caused by, for example, the user's inhalation with respect to the aerosol generating device. In this case, a resistance value of the resistor 174b included in the sensor unit 170b according to the deformation d2 may be greater than or equal to the first threshold, and thus a puff may be detected.

Although not illustrated in FIGS. 7A to 7C, a plurality of sensor units 170b may be arranged along the air flow passage 160. For example, as the sensor unit 170b is arranged at a location closer to the outside of the aerosol generating device, the sensor unit 170b may include the base 172 having a smaller length. As the sensor unit 170b is arranged at a location distant from the aerosol generating device, the sensor unit 170b may include the base 172b having a greater length.

As the length of the base 172b increases, the sensor unit 170b may be sufficiently deformed such that a change in a resistance needed for detecting a puff may be sensed even when the sensor unit 170b is arranged at a deep location inside the aerosol generating device.

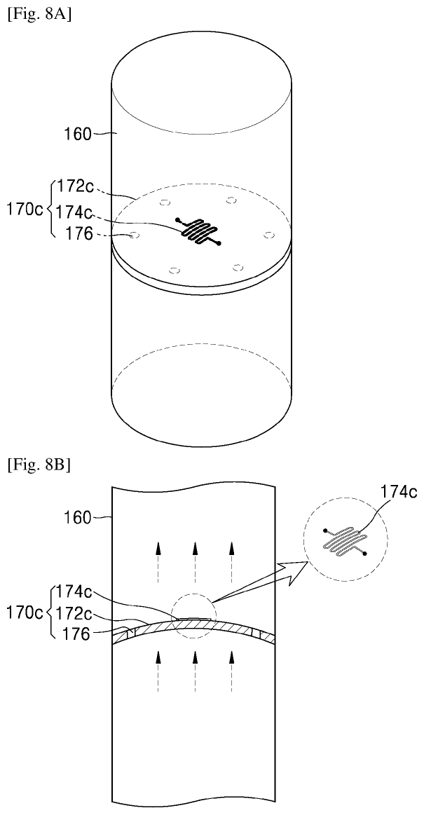

FIG. 8A is a view illustrating an aspect of a sensor unit according to another embodiment. FIG. 8B is a view illustrating another aspect of a sensor unit according to another embodiment.

Referring to FIGS. 8A and 8B, a sensor unit 170c may include a plurality of holes 176 for allowing an air flow to pass, and may be arranged to cover at least a portion of a cross-sectional area of an air flow passage 160. Here, the air flow passage 160 illustrated in FIGS. 8A and 8B may be a portion of the air flow passage 160 illustrated in FIGS. 1 to 3.

A base 172c may be attached to an inner surface of the air flow passage 160. For example, the base 172c may be coupled, adhered, or welded along the circumferential direction of the inner surface of the air flow passage 160 having a cylindrical shape, but is not limited thereto.

The plurality of holes 176 through which an air flow may pass may be arranged in at least one area of the base 172c, and a resistor 174c may be arranged in another area of the base 172c. For example, the resistor 174c may be arranged at a central portion of the base 172c, and the plurality of holes 176 may be arranged at an edge portion of the base 172c.

Although at least a portion of the air flow passage 160 is covered by the sensor unit 170c, a portion of the air flow may pass through the plurality of holes 176 in the air flow passage 160. Here, the remaining portion of the air flow that does not pass through the plurality of holes 176 may cause deformation of the base 172c by applying pressure to the base 172c.

Referring to FIG. 8A, when there is no air flow in the air flow passage 160, the sensor unit 170c may not be deformed, and a resistance of the resistor 174c may not change. By contrast, referring to FIG. 8B, when there is an air flow in the air flow passage 160, the sensor unit 170c may be deformed, and a change in a resistance due to the deformation of the resistor 174c may be sensed.

For example, the central portion of the base 172c may become convex towards the air flow direction, and the resistor 174c arranged at the central portion of the base 172c may be changed in length and/or cross-sectional area in response to the deformation of the base 172c. As a result, a change in a resistance may be sensed by the sensor unit 170c.

The number of the holes 176 is not limited to the embodiment shown in FIG. 8A. Due to the holes 176, even when the sensor unit 170c is arranged to cover at least a portion of the air flow passage 160, the air flow may not be blocked inside an aerosol generating device.

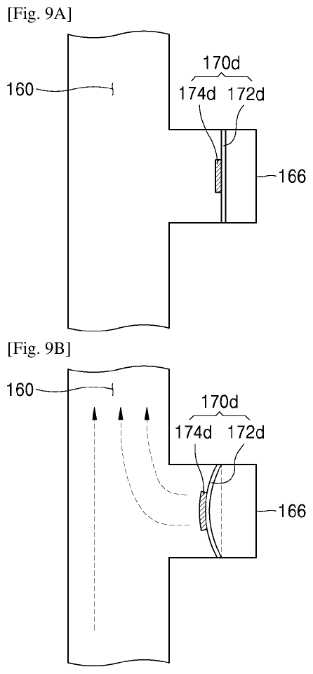

FIG. 9A is a view illustrating an aspect of a sensor unit according to another embodiment. FIG. 9B is a view illustrating another aspect of a sensor unit according to another embodiment.

Referring to FIGS. 9A and 9B, an aerosol generating device according to another embodiment may further include a chamber 166 branched from one point of an air flow passage 160, such that an air flow may enter and exit the chamber 166.

The chamber 166 may be a separate space in which a sensor unit 170d may be arranged, and may be branched from one point of the air flow passage 160 and located in a direction toward the outside of the air flow passage 160. For example, as shown in FIGS. 9A and 9B, the chamber 166 may be a space that extends from one point of the air flow passage 160 in a direction different from the direction in which the air flow passage 160 extends. As another example, the chamber 166 may be a separate space connected to the air flow passage 160.

As the sensor unit 170d is arranged in the chamber 166, the sensor unit 170d may measure or sense a change in a resistance of a resistor 174d at a location which does not obstruct an air flow in the air flow passage 160.

In an embodiment, a base 172d may be arranged to cover at least a portion of the chamber 166. For example, the base 172d may have a shape of a beam, and both ends of the beam may be attached to an inner wall of the chamber 166 such that the base 172d covers a portion of a cross-sectional area of the chamber 166. As another example, the base 172d may have a film shape and may be attached along the inner wall of the chamber 166 such that the base 172d covers the entire cross-sectional area of the chamber 166. In this case, the resistor 174d may be included in the base 172d having the film shape.

The sensor unit 170d arranged on the inner wall of the chamber 166 may not obstruct the flow of the air flow, and the sensor unit 170d may be firmly fixed to the inner wall of the chamber 166, thereby improving the structural stability of the sensor unit 170d.

Referring to FIG. 9A, when there is no air flow in the air flow passage 160, the sensor unit 170d may not be deformed and a resistance due to the deformation of the resistor 174d may not change. By contrast, referring to FIG. 9B, when there is an air flow in the air flow passage 160, the sensor unit 170d may be deformed and a change in a resistance due to the deformation of the resistor 174d may be sensed.

For example, an air flow formed according to a user's inhalation may form negative pressure in the chamber 166, and thus, the base 172d may be deformed. Accordingly, the length or cross-sectional area of the resistor 174d may be changed, and as a result, the resistance of the resistor 174d may be changed.

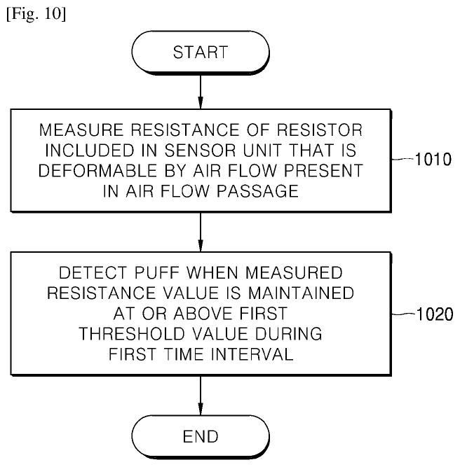

FIG. 10 is a flowchart illustrating an operation method of an aerosol generating device, according to an embodiment.

Referring to FIG. 10, an operation method of an aerosol generating device according to an embodiment includes operations processed sequentially in the aerosol generating devices 100a, 100b, and 100c illustrated in FIGS. 1 to 3. Accordingly, the above description of the aerosol generating devices 100a, 100b, and 100c of FIGS. 1 to 3, even if omitted below, may be equally applied to the operation method of FIG. 10.

In operation 1010, a processor may measure a resistance value of a resistor included in a sensor unit. Here, the sensor unit may be deformed by an air flow in an air flow passage.

The processor may measure, at a preset time, the resistance value of the resistor included in the sensor unit. For example, the processor may measure and/or record, every 0.01 second, the resistance value of the resistor included in the sensor unit. The processor may also generate a graph (e.g., the graph of FIG. 4) or a trend line that represents a change in a resistance value over time, by using the recorded resistance value.

According to an embodiment, the processor may determine whether or not a heater for heating an aerosol generating material is operating, and perform detection of puff (i.e., measure the resistance value of the sensor unit) only when the heater is operating. As such, since the resistance value is not measured and/or recorded while the heater is not operating, power may be saved.

In operation 1020, the processor may detect a puff when the measured resistance value is maintained at or above a first threshold value during a first time interval (i.e., for at least a certain time). For example, when the resistance value is maintained, during a predefined time, at a value that is great such that the resistance value is seen as occurring by a user's inhalation with respect to the aerosol generating device, the processor may detect a puff (i.e., determine that the user's inhalation has occurred).

In detail, based on data about the resistance value measured or recorded over time in operation 1010, the processor may determine that the user's inhalation has occurred when the resistance value is maintained at or above a threshold value during a predefined time.

In another embodiment, the processor may detect a puff when the measured resistance value is maintained at or above a second threshold value during a second time interval after being maintained at or above the first threshold value during the first time interval. Here, the second time interval may be shorter than the first time interval, and the second threshold value may be less than the first threshold value.

Therefore, the processor may implement a more accurate puff detection function by additionally considering an end of the inhalation in which the resistance value is restored, as well as a start of the inhalation in which a resistance value is changed and maintained.

According to an embodiment, in operation of detecting a puff, the processor may determine whether or not the heater for heating the aerosol generating material is operating, and perform detection of a puff (e.g., measure the resistance of the sensor unit) only when the heater is operating. As such, since the resistance value is not measured and/or recorded while the heater is not operating, power may be saved.

In an embodiment, the processor may output a notification of the detected puff in a predefined method. The predefined method may include at least one of a visual method, an auditory method, and a tactile method. The processor may output the notification of the detected puff by controlling a user interface.

For example, the processor may display the number of detected puffs on a display. As another example, when the number of remaining puffs reaches a predefined number, the processor may control a speaker to output a notification or control a vibration motor to vibrate.

One embodiment may also be implemented in the form of a computer-readable recording medium including instructions executable by a computer, such as a program module executable by the computer. The computer-readable recording medium may be any available medium that can be accessed by a computer and includes both volatile and nonvolatile media, and removable and non-removable media. In addition, the computer-readable recording medium may include both a computer storage medium and a communication medium. The computer storage medium includes all of volatile and nonvolatile, and removable and non-removable media implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer media.

This disclosure has been particularly shown and described with reference to embodiments thereof. However, it will be understood by those of ordinary skill in the art that various changes in form and details may be made therein without departing from the spirit and scope of the disclosure as defined by the appended claims. The embodiments should be considered in a descriptive sense only and not for purposes of limitation. Therefore, the scope of the disclosure is defined not by the detailed description of the disclosure but by the appended claims, and all differences within the scope will be construed as being included in the present disclosure.

1. An aerosol generating device comprising:
a housing including an air flow passage;
a sensor deformable by an air flow in the air flow passage, and including a resistor having a resistance value that varies according to a degree of deformation of the sensor; and
a processor electrically connected to the sensor, and configured to:
measure the resistance value of the resistor; and
detect a puff based on the measured resistance value being maintained at or above a first threshold value during a first time interval.

2. The aerosol generating device of claim 1, wherein the processor is configured to determine that a puff is detected based on the measured resistance value being maintained at or above a second threshold value during a second time interval after being maintained at or above the first threshold value during the first time interval.

3. The aerosol generating device of claim 2, wherein the second threshold value is less than the first threshold value, and the second time interval is shorter than the first time interval.

4. The aerosol generating device of claim 1, wherein the processor is configured to output a notification of detection of the puff via a predefined method.

5. The aerosol generating device of claim 4, wherein the predefined method includes at least one of a visual method, an auditory method, and a tactile method.

6. The aerosol generating device of claim 1, further comprising a heater configured to heat an aerosol generating material, wherein the processor is configured to control power supplied to the heater when the puff is detected.

7. The aerosol generating device of claim 1, further comprising a heater configured to heat an aerosol generating material, wherein the processor is configured to perform detection of the puff when the heater operates.

8. The aerosol generating device of claim 1, wherein the sensor includes a base that is deformable by the air flow, and the resistor is arranged on the base such that the resistance value of the resistor changes in response to deformation of the base.

9. The aerosol generating device of claim 8, wherein the base is a cantilever, and protrudes from an inner side of the air flow passage.

10. The aerosol generating device of claim 8, wherein the base includes a plurality of holes configured to allowing passage of the air flow, and is arranged to cover at least a portion of the air flow passage.

11. The aerosol generating device of claim 8, further comprising a chamber branched from one point of the air flow passage such that the air flow enters the chamber from the air flow passage and exits the chamber to the air flow passage, wherein the sensor is arranged in the chamber.

12. The aerosol generating device of claim 11, wherein the base is arranged to cover at least a portion of the chamber.

13. The aerosol generating device of claim 1, wherein the resistor is a strain gauge.

14. The aerosol generating device of claim 13, wherein the sensor includes an array including the strain gauge.

15. An operation method of an aerosol generating device, the operation method comprising:
measuring a resistance value of a resistor included in a sensor that is deformable by an air flow in an air flow passage, wherein the resistance value that varies according to a degree of deformation of the sensor; and
detecting a puff based on the measured resistance value being maintained at or above a first threshold value during a first time interval.
